(19) United States
(12) Patent Application Publication
(10) Pub. No.: US 2026/0169675 A1
(43) Pub. Date: Jun. 18, 2026

(54) WIRELESS COMMUNICATION OF WEARABLE DEVICE ACCELEROMETER DATA FOR SPEECH INPUT RECOGNITION

(71) Applicant: GOOGLE LLC, Mountain View, CA (US)

(72) Inventors: Irvin Owens, Alameda, CA (US); Jeff Peil, Livonia, MI (US); Maxwell McKinnon, San Mateo, CA (US); Jens Heitkaemper, Mountain View, CA (US)

(21) Appl. No.: 18/978,729

(22) Filed: Dec. 12, 2024

(51) Int. Cl. G06F 3/16; G01P 15/18; G10L 15/183; G10L 19/008

(52) U.S. Cl. CPC G06F 3/162; G10L 19/008; G01P 15/18; G10L 15/183

(57) ABSTRACT

The processing of speech input captured by a wearable device may be facilitated by communicating accelerometer data captured by one or more accelerometers of the wearable device to an external device as audio data along with audio data captured by one or more microphones of the wearable device. The accelerometer data may be communicated, for example, using a narrowband audio signal, an audio signal including accelerometer data captured at multiple sampling frequencies, and/or a spread-spectrum audio signal, and may be used to enhance speech recognition of the speech input captured by the microphone(s) of the wearable device.

### BACKGROUND

Humans may engage in human-to-computer dialogs with interactive software applications referred to herein as “automated assistants” (also referred to as “chatbots,” “interactive personal assistants,” “intelligent personal assistants,” “personal voice assistants,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input. An automated assistant generally responds to a command or request by providing responsive user interface output, which may include audible and/or visual user interface output.

Automated assistants enable users to obtain information, access services, and/or perform various tasks. For example, users are able to execute searches, get directions, and in some cases, interact with third party computing services. Users may also be able to perform a variety of actions, such as calling cars from ride-sharing applications, ordering goods or services (e.g., pizza), controlling smart devices (e.g., light switches), making reservations, and so forth.

Automated assistants may converse with users using speech recognition and natural language processing, with some also utilizing machine learning and other artificial intelligence technologies, for instance, to predict user intents. In this regard, the quality of the captured audio of a spoken utterance can have a significant impact on not only the recognition of the utterance, but also the natural language interpretation thereof. Spoken utterances may be received, however, in a multitude of environments, including environments subject to significant background noise.

As an example, users of wearable devices such as earbuds, headphones, eyewear, and the like are able to access automated assistants in a wide variety of environments, with microphones built into the wearable devices used to capture audio of spoken utterances. In many such environments, however, the microphones may also capture significant background noise, including the speech of other individuals in the immediate vicinity of a user. As such, a continuing need exists for improving the quality of audio captured by wearable devices to optimize the processing of spoken utterances by automated assistants and the like.

### SUMMARY

Techniques are described herein for facilitating the processing of speech input captured by a wearable device by communicating accelerometer data captured by one or more accelerometers of the wearable device to an external device as audio data along with audio data captured by one or more microphones of the wearable device. The accelerometer data may be communicated, for example, using a narrowband audio signal, an audio signal including accelerometer data captured at multiple sampling frequencies, and/or a spread-spectrum audio signal, and may be used to enhance speech recognition of the speech input captured by the microphone(s) of the wearable device.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a block diagram of an example computing environment in which implementations disclosed herein may be implemented.

FIG. 2 is a flowchart illustrating an example operational sequence for communicating a speech input from a wearable device to an external device, in accordance with various implementations.

FIG. 3 is a flowchart illustrating an example operational sequence for processing a speech input received from a wearable device in an external device, in accordance with various implementations.

FIG. 4 is a flowchart illustrating another example operational sequence for processing a speech input received from a wearable device in an external device, in accordance with various implementations.

FIG. 5 is a flowchart illustrating another example operational sequence for communicating a speech input from a wearable device to an external device, in accordance with various implementations.

FIG. 6 is a flowchart illustrating yet another example operational sequence for communicating a speech input from a wearable device to an external device, in accordance with various implementations.

FIG. 7 illustrates an example architecture of a computing device.

### DETAILED DESCRIPTION

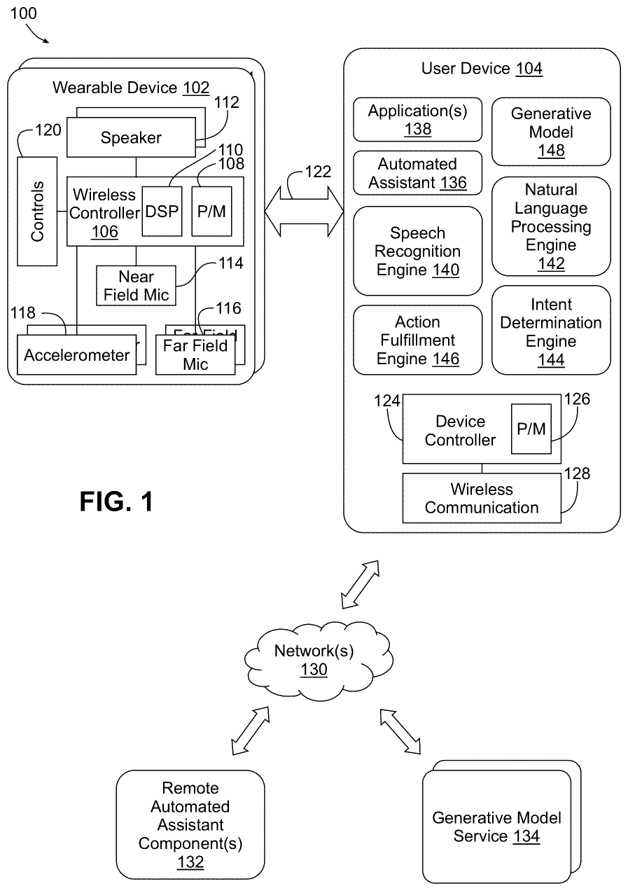

Now turning to FIG. 1, an example environment 100 in which techniques disclosed herein may be implemented is illustrated. The example environment 100 includes one or more wearable devices 102 interfaced with a user device 104. Each wearable device 102 may be implemented, for example, as an earbud, a headphone, eyewear, or practically any electronic device capable of capturing speech input from a user while being worn by the user.

A pair of wireless earbud-type wearable devices 102 is illustrated in FIG. 1, and it will be appreciated that in some implementations, only one of the wireless earbud-type wearable devices 102 may communicate with a user device 104, with additional communication between the two wireless earbud-type wearable devices to pass audio and/or control data between the two devices. In such instances, the wireless earbud-type wearable device that communicates with the user device may be designated as a primary device, and the other wireless earbud-type wearable device may be designated as a secondary device. In some instances, which device operates as the primary device and which operates as the secondary device may change from time to time, even within the same communication session with the user device. For other types of wearable devices, e.g., headphones, eyewear, or earbuds coupled to one another via a band or wire, or devices that are not intended to be used with both ears, only a single wearable device may be used.

Each wearable device 102 may include a wireless controller 106 including one or more processors and one or more memories (collectively represented at 108), and in some instances, may also include dedicated circuitry for enhancing signal processing, e.g., a digital signal processing (DSP) component 110. Wearable device 102 may also include one or more playback devices or speakers 112 for presenting audio information to a user, as well as one or more microphones 114, 116 for capturing speech input from the user. In some implementations, for example, one or more near field microphones 114 and/or one or more far field microphones 116 may be utilized to capture audio from the surrounding environment, including audio associated with speech input from a user. Far field microphones 116, for example, may be used in connection with active noise cancellation (ANC), and in some instances, in connection with enhancing audio associated with a speech input captured from near field microphone 114 by canceling out audio captured in the surrounding environment. For the purposes of this disclosure, a microphone that is used to generate the primary audio signal representative of a speech input is also referred to herein as a primary microphone, while any microphone used to capture audio data that is used to enhance the primary audio signal is also referred to herein as a secondary microphone, and it will be appreciated that in some implementations, a given microphone may function as a primary microphone or a secondary microphone in different situations, so a microphone may not be solely used as a primary or secondary microphone in some implementations.

Each wearable device 102 may also include one or more accelerometers 118, e.g., capable of capturing acceleration data in one or more dimensions (e.g., three dimensions along X, Y, and Z axes in some implementations). Accelerometers 118 may be used, for example, in connection with spatial audio, as well as in connection with detecting motion, e.g., to detect when a wearable device is picked up or put down, to detect user inputs such as taps, to detect movement of a user's head, or to detect overall movement of the user in connection with fitness tracking. In addition, as will become more apparent below, accelerometers 118 may be used in connection with enhancing audio associated with a speech input captured from near field microphone 114, in some instances by sensing a user's voice as it is conducted through the bones of the user's head.

Each wearable device 102 may also include one or more user controls 120 (e.g., buttons, sliders, touch-sensitive sensors, etc.) for interacting with the device. Additional components, e.g., other sensors such as gyroscopes, infrared sensors, etc. ; batteries and associated charging components; etc. may also be included in each wearable device 102, but are not illustrated in FIG. 1. In addition, while controller 106 is illustrated as a wireless controller including integrated wireless communication functionality, a separate wireless communication component may be used in some implementations.

User device 104 is an external device relative to each wearable device 102, and is interfaced, for example, over a wireless communication network 122 such as a Bluetooth-compatible network or another short range wireless network such as a Wi-Fi network, an NFC network, etc. In some implementations, a user device 104 may be a mobile phone or tablet, although a user device in other implementations may be a laptop, a desktop computer, a set top box, a standalone interactive speaker, a smart appliance such as a smart television, a gaming console, a virtual or augmented reality computer, or practically any other computing device capable of being utilized by a user.

From a hardware perspective, user device 104 includes a device controller 124 including one or more processors and one or more memories (collectively represented at 126), as well as a wireless communication component 128 for communicating with wearable device 102 over network 122, as well as communicating with additional remote devices, components, services, etc. accessible via one or more short range, local area, and/or wide area networks (e.g., the Internet) 130. For example, as will be discussed in greater detail below, a user device may communicate with one or more remote and/or cloud-based automated assistant components 132 and/or one or more generative model services 134, which may be implemented on one or more computing systems that are communicatively coupled to user device 104 via networks 130.

Each wearable device 102, user device 104, computing device(s) operating remote or cloud-based automated assistant components 132, and computing device(s) operating generate model service 134 may include one or more memories for storage of data and software applications, one or more processors for accessing data and executing applications, and other components that facilitate communication over a network. The operations performed by any of the aforementioned devices may be distributed across multiple computer systems, e.g., as computer programs running on one or more computers in one or more locations that are coupled to each other through a network. In various implementations, for example, some or all of the functionality of an automated assistant may be distributed between multiple computer systems, or even to a user and/or wearable device. In some implementations, for example, the assistant functionality discussed herein may be performed entirely within a user device (or multiple user devices), e.g., so that such functionality is available to a user even when no online connectivity exists. As such, in some implementations, a user device may include a client device, while in other implementations a user device may include one or more computer systems remote from a client device, or even a combination of a client device and one or more remote computer systems, whereby a user device is a distributed combination of devices. A user device may therefore in various implementations be considered to include any electronic device that implements any of the functionality of an automated assistant.

User device 104 in the illustrated implementation is generally a computing device upon which an instance of an automated assistant client 136, by way of its interactions with one or more remote and/or cloud-based automated assistant components 132, may form what appears to be, from the user's perspective, a logical instance of an automated assistant with which the user may engage in a human-to-computer dialog. For the sake of brevity and simplicity, the term “automated assistant” as used herein as “serving” a particular user will refer to the combination of an automated assistant client 136 executing on a user device 104 operated by the user and one or more remote and/or cloud-based automated assistant components 132 (which may be shared amongst multiple automated assistant clients in some implementations), although it will be appreciated that, as noted above, an automated assistant for a particular user may be entirely resident on a user device or in a cloud-based service.

User device 104 may also include instances of various applications 138, which in some implementations may interact with or otherwise be supported by an automated assistant. In addition, an automated assistant engages in human-to-computer dialog sessions with one or more users via user interface input and output devices of user device 104. Moreover, various additional components are resident in user device 104 in connection with supporting such sessions.

For example, a speech recognition engine 140 may be used to generate or transcribe text (and/or other suitable representations or embeddings) from speech or spoken audio input from a user, while a natural language processing engine 142 may be used to generate one or more entities. In some implementations, speech recognition engine 140 is also a streaming engine, such that voice input is converted to text on a token-by-token basis and in real time or near-real time, such that tokens may be output from engine 140 effectively concurrently with a user's speech, and thus prior to a user enunciating a complete spoken request. Speech recognition engine 140 may rely on one or more acoustic and/or language models, which together model a relationship between an audio signal and phonetic units in a language, along with word sequences in the language. In some implementations, a single model may be used, while in other implementations, multiple models may be supported, e.g., to support multiple languages, multiple speakers, etc.

Whereas speech recognition engine 140 converts speech to text, natural language processing engine 142 attempts to discern the semantics or meaning of the text output by engine. For example, natural language processing engine 142 may rely on one or more grammar models to map action text to particular computer-based actions and to identify entity text and/or other text that constrains the performance of such actions. In some implementations, a single model may be used, while in other implementations, multiple models may be supported, e.g., to support different computer-based actions or computer-based action domains (i.e., collections of related actions such as communication-related actions, search-related actions, audio/visual-related actions, calendar-related actions, device control-related actions, etc.). As an example, a grammar model (stored on user device 104 and/or remote computing device(s)) may map computer-based actions to action terms of voice-based action queries such as the action terms “tell me more about”, “directions to”, “navigate to”, “watch”, “call”, “email”, “contact”, etc.

Moreover, each user device 104 may also include an intent determination engine 144 and an action fulfillment engine 146. Intent determination engine 144, for example, may take the output of natural language processing engine 142 to determine the intent of a spoken input of a user. Further, in some implementations, intent determination engine 144 may process other forms of input, e.g., text input entered in an application, in order to determine the intent of a particular input. Action fulfillment engine 146 may be used to act upon the determined intent, e.g., to initiate and/or coordinate performance of various actions. Engine 146, for example, may issue calls to various applications, online services, or assistant-related functionality to cause requested actions to be performed.

In addition to or in lieu of an automated assistant, a user device 104 may also include a generative model 148, e.g., a large language model (LLM) or multi-modal model capable of processing various forms of input and generating a response thereto. As will become more apparent below, for example, audio and/or accelerometer data associated with speech inputs may be input directly to generative model 148 and/or to a generative model service 134 to generate a response or otherwise fulfill an action without having to perform distinct and intermediate steps of speech recognition, natural language processing and/or intent determination.

It will be appreciated that some or all of the functionality of any of the aforementioned engines and components illustrated as being resident in user device 104 may be implemented in a remote automated assistant component in other implementations. Specifically, any of the operations discussed hereinafter as being performed by a user device may, in some implementations, be performed entirely or in part by a remote service. Therefore, the invention is not limited to the specific allocation of functionality shown in FIG. 1.

### Wireless Communication of Wearable Device Accelerometer Data for Speech Input Recognition

As noted above, it may be desirable in some implementations to facilitate the processing of speech input captured by a wearable device by communicating accelerometer data captured by one or more accelerometers of the wearable device to an external device as audio data along with audio data captured by one or more microphones of the wearable device. The accelerometer data may be used, for example, to enhance the recognition of the speech input, e.g., by canceling or otherwise compensating for other noise in the environment and/or by amplifying vocal audio originating from a user. It will be appreciated, in particular, that for a wearable device that is worn on or proximate the head of a user, e.g., an earbud, a user's voice will generally propagate through the user's body, specifically through the bones of the head, as vibrations that may be sensed by an accelerometer.

The accelerometer data may be used in some implementations, for example, in connection with active noise cancellation or reduction, or with otherwise enhancing audio data collected by one or more microphones of a wearable device while a user of the wearable device is speaking, in order to enhance the user's speech input, and in some instances, to enhance speech recognition of the user's speech input. Enhancing the speech input, in many instances, involves improving the signal to noise ratio (S/R) between the user's spoken voice (the signal) and any background sounds (the noise) captured by the microphones of the wearable device. In some implementations, for example, the accelerometer data may be used to improve a speech recognition metric such as Word Error Rate (WER). In some implementations, WER is defined as the number of errors in word recognition divided by the number of words spoken (so a lower WER is better). In other implementations, other metrics such as successful interactions (SI), which are related to the number or rate of speech inputs that are properly recognized and handled by an automated assistant, may be used.

One technical challenge with the use of accelerometer data, particularly in connection with wearable devices, is communicating the accelerometer data to an external device for use in connection with speech recognition or other processing. For many wearable devices, for example, the wireless communication protocols used to communicate audio data between a wearable device and an external device are bandwidth constrained. Moreover, the accelerometer data generally needs to be temporally aligned with any audio data captured by the wearable device's microphone(s), since fundamentally both the accelerometer data and the audio data are effectively capturing different representations of the same physical phenomena.

In the implementations discussed herein, however, these technical challenges may be addressed at least in part by communicating accelerometer data within an audio channel of a multi-channel audio signal (e.g., a stereo audio signal having left and right audio channels) and in an audio data format that is compatible with various audio processing hardware and/or software, and that is compatible with various wireless communication protocols. Moreover, in some implementations, the accelerometer data may be communicated in a manner that does not substantially interfere with the fidelity of any audio data communicated within the same multi-channel audio signal, or in some instances, with the fidelity of any audio data communicated within the same channel of a multi-channel audio signal. Further, in some instances, the accelerometer data may be shifted to a higher or lower frequency range to further avoid interference with any audio data communicated within the same channel of a multi-channel audio signal. In addition, in some implementations, encoding of accelerometer data into a multi-channel audio signal may ensure coherent timing with microphone audio data with low latency, while maintaining sufficient audio fidelity of the microphone audio data within the bandwidth constraints of the wireless network.

In some implementations, for example, the accelerometer data may be communicated using a narrowband audio signal that is within a predetermined frequency range, e.g., within about 2000 Hz, and in some implementations, within about 1000 Hz, or even within about 500 Hz. In some implementations, for example, the accelerometer data (e.g., the sensed magnitudes in the accelerometer data) may be sampled at a predetermined frequency to generate an audio signal (e.g., a 16 kHz audio signal in some implementations) and then passed through a low pass filter to generate the narrowband audio signal within a range of about 0 Hz to about 2000 Hz, within a range of about 0 Hz to about 1000 Hz, or within a range of about 0 Hz to about 500 Hz. The narrowband audio signal may also be mixed with audio data captured from one or more microphones of a wearable device in some implementations, such that any audio data outside of the frequency range of the narrowband audio signal is substantially unaltered. In some implementations, the narrowband audio signal may also be shifted to a higher base frequency (including, in some implementations, at least partially above an audible frequency range of most humans), but still within a narrow frequency range. The resulting audio signal, whether or not mixed with any other microphone audio data, may be passed to encoding and compression logic as a raw microphone signal in some implementations and combined as one channel of a multi-channel audio signal with audio data captured from one or more primary microphones of the wearable device and communicated in the other channel of the multi-channel audio signal. The encoding and compression logic, for example, may apply an audio codec such as SBC, LC-3, or another suitable audio codec to generate encoded and compressed data suitable for communication over a wireless communication network such as a Bluetooth network. In addition, in implementations where a primary microphone audio channel is primarily used to receive speech input, the addition of accelerometer data in an otherwise unused audio channel provides an ability to enhance speech recognition without substantial additional processing or communication overhead.

An external device may then decode and decompress the data received over the Bluetooth network to extract the respective audio signals from the different channels of the multi-channel audio signal, and active noise cancellation or reduction functionality, implemented in hardware and/or software on the external device, may enhance any speech input captured by the primary microphone(s) of the wearable device using the accelerometer data and/or any audio data captured by any secondary microphones of the wearable device. In some implementations, due to the representation of the accelerometer data as a narrowband audio signal, only minor (if any) modifications may be required to any audio library that processes the accelerometer data in connection with enhancing a speech input, even if the audio library is only configured to process audio data.

In addition, in some implementations, the accelerometer data may be communicated using an audio signal incorporating accelerometer data captured at multiple sampling frequencies. It will be appreciated, for example, that multiple accelerometer data streams may be captured by the accelerometers of some wearable devices, and these multiple data streams may be captured at different sampling frequencies in some implementations. For example, where the accelerometer data has multi-axis data (e.g., X axis data, Y axis data, and Z axis data representing acceleration along three mutually orthogonal axes), the accelerometer data from each axis may be sampled at different sampling frequencies, e.g., 13 kHz, 13.05 kHz, and 13.1 kHz in some implementations, with the amplitude captured representing some factor of the original accelerometer value. In the external device, the deltas from sample to sample may be computed and used to convert the accelerometer data back to X, Y, Z spatial values. Moreover, the sampling frequencies may be filtered out in the external device, e.g., using a bandpass or a high-pass filter.

Furthermore, in some implementations, the accelerometer data may be communicated within a spread-spectrum audio signal, e.g., using a Code Division Multiple Access (CDMA) encoding scheme that encodes accelerometer data, whether combined into a single data stream or separate axis-specific data streams, over a frequency spectrum. In some instances, the frequency spectrum may correspond to at least a portion of the audio spectrum, such that the spread-spectrum audio signal may be processed using audio codecs and libraries and decoded in an external device with minor, if any, modifications to any audio processing hardware and/or software.

In addition, in some implementations, two or more of the aforementioned techniques may be combined. As such, while the discussion hereinafter will focus on implementations that utilize each of the aforementioned techniques individually, the invention is not so limited. Furthermore, while the implementations discussed hereinafter will focus on communication over a Bluetooth network and utilizing a Bluetooth-compatible codec such as SBC or LC-3, it will be appreciated that other wireless network protocols, as well as other codecs, may be used in other implementations, so the invention is not limited to the specific wireless communication and encoding/decoding and compression/decompression protocols discussed herein.

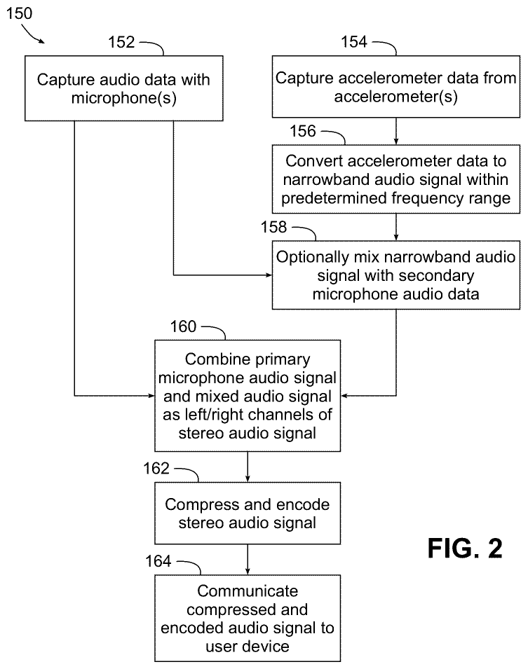

FIG. 2 illustrates an example operational sequence 150 for communicating a speech input from a wearable device to an external device, in accordance with various implementations. In block 152, audio data is captured with one or more microphones of the wearable device, e.g., one or more primary microphones, and in some implementations, one or more secondary microphones. Concurrently, accelerometer data is captured from one or more accelerometers of the wearable device in block 154.

In block 156, the accelerometer data is converted to a narrowband audio signal within a predetermined frequency range, e.g., a range of about 2000 Hz, 1000 Hz, or 500 Hz. For example, in some implementations the accelerometer data from multiple axes may be sampled at a predetermined frequency (e.g., 16 kHz) and combined (e.g., via averaging) to define a combined acceleration magnitude value, and the resulting data stream may be filtered by a low pass filter to generate a narrowband audio signal. In some implementations, the resulting narrowband audio signal may also be frequency shifted to a higher frequency. Then, in block 158, the narrowband accelerometer audio signal may optionally be mixed with the secondary microphone audio data.

Next, in block 160, the primary microphone audio signal and the mixed audio signal (or alternatively the narrowband accelerometer audio signal, if no secondary microphones are used) are combined into left/right channels of a multi-channel (e.g., stereo) audio signal, and in block 162, the multi-channel audio signal is compressed and encoded, e.g., using an audio codec such as SBC or LC-3. The compressed and encoded audio signal is then communicated to an external device (e.g., a mobile phone) in block 164. It will be appreciated that some multi-channel audio signals may have more than two channels (e.g., 5.1 or 7.1 surround audio signals, among others), so the invention is not limited to a two-channel (stereo) audio signal. In particular, an accelerometer audio signal may be assigned to various other channels in a multi-channel audio signal, e.g., a surround channel, a subwoofer channel, a center channel, or any other available channel in a multi-channel audio signal.

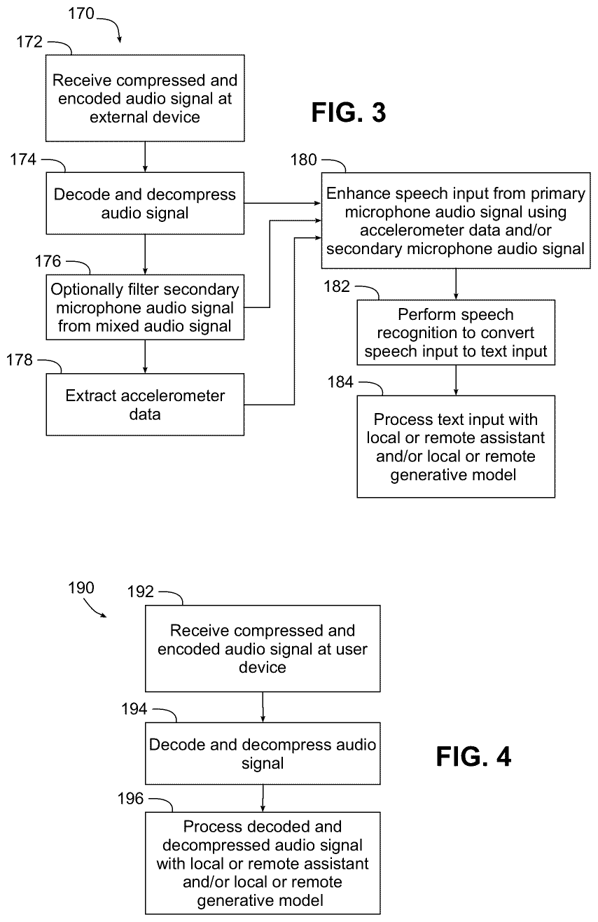

Reception and processing of the compressed and encoded audio signal is handled in the external device as illustrated by operational sequence 170 of FIG. 3. In block 172, the compressed and encoded audio signal is received by the external device, and in block 174, the audio signal is decoded and decompressed, resulting in first and second audio signals from the first and second (e.g., left and right) audio channels of the decoded and decompressed audio signal that correspond generally to the primary microphone audio signal and the mixed (or accelerometer) audio signal generated by the wearable device in block 158 of FIG. 2. As illustrated in block 176, any secondary microphone audio signal may be filtered from the mixed audio signal, resulting in narrowband audio and secondary microphone audio signals generally corresponding to the audio signals input to block 158 of FIG. 2.

Accelerometer data is then extracted from the narrowband audio signal in block 178, e.g., in the reverse manner to which it was converted in block 156 of FIG. 2 (including any frequency shifting as needed), and each of the accelerometer data, the primary microphone audio data, and the secondary microphone audio data is provided to block 180 to enhance the speech input from the primary microphone audio signal using one or both of the accelerometer data and the secondary microphone audio data, using any suitable ANC algorithm.

Next, in block 182, the enhanced speech input is then processed by a speech recognition engine (e.g., speech recognition engine 140 of FIG. 1), and in block 184 the resulting text input is processed using a local or remote automated assistant or a local or remote generative model. It will be appreciated, for example, that a generative model in some implementations may include comparable functionality to an automated assistant (or an automated assistant may utilize one or more generative models in connection with processing speech inputs), and as such, may generate responses and or fulfill actions in a comparable manner to an automated assistant.

For example, if processed by a local automated assistant, natural language processing, intent determination and action fulfillment may be performed locally in the external device (e.g., a user's mobile phone), e.g., by engines 142, 144, and 146 of FIG. 1. Alternatively, if processed by a remote automated assistant, one or more of natural language processing, intent determination and/or action fulfillment may be handled via one or more remote automated assistant components such as components 132 of FIG. 1.

If processed by a local generative model, e.g., generative model 148 of FIG. 1, the text input may be provided as an input to the generative model and the response of the model may be presented to the user. Likewise, if processed by a remote generative model (e.g., a generative model service 134 of FIG. 1), the text input may be communicated to and provided as an input to the remote generative model and the response of the model may be communicated back to external device for presentation to the user.

As another alternative, and as illustrated in operational sequence 190 of FIG. 4, rather than enhancing a primary microphone audio signal and performing speech recognition on the enhanced primary microphone signal in order to generate a text input in the manner described above in connection with FIG. 3, one or more of the audio signals and accelerometer data received from a wearable device may be used as direct inputs into a local or remote automated assistant or a local or remote generative model. Specifically, the compressed and encoded audio signal from the wearable device is received by the external device in block 192, and in block 194, the audio signal is decoded and decompressed, resulting in first and second audio signals from the first and second (e.g., left and right) audio channels of the decoded and decompressed audio signal that correspond generally to the primary microphone audio signal and the mixed (or accelerometer) audio signal generated by the wearable device in block 158 of FIG. 2. In addition, while not illustrated in FIG. 4, in some implementations the narrowband accelerometer audio signal and any secondary microphone audio signals may be separated as described above in connection with block 176 of FIG. 3.

One or more of the audio signals may then be processed by a local or remote automated assistant or a local or remote generative model in block 196, using the audio signals as direct inputs thereto. Thus, for example, where a generative model is trained to process audio and/or accelerometer data, some of the aforementioned preprocessing, such as speech input enhancement (or active noise cancellation), speech recognition, natural language processing and/or intent determination, may need to be performed in some implementations.

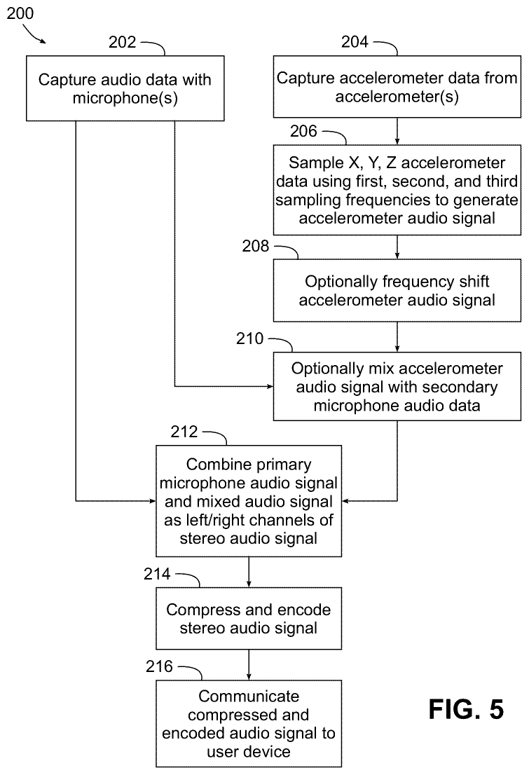

FIG. 5 next illustrates another operational sequence 200 for communicating a speech input from a wearable device to an external device, in accordance with various implementations, and utilizing multi-axis accelerometer data sampled at different sampling rates. In block 202, audio data is captured with one or more microphones of the wearable device, e.g., one or more primary microphones, and in some implementations, one or more secondary microphones. Concurrently, accelerometer data is captured from one or more accelerometers of the wearable device in block 204.

In block 206, accelerometer data for multiple axes (e.g., two or more of X axis accelerometer data, Y axis accelerometer data, and Z axis accelerometer data) may be sampled at different sampling frequencies. In one example implementation, first, second, and third axis accelerometer data may be a sampled at respective first, second, and third sampling frequencies, e.g., 13 kHz, 13.05 kHz, and 13.1 kHz, with the amplitude captured representing some factor of the original accelerometer value, and resulting in the generation of an accelerometer audio signal having sampled accelerometer data incorporated therein. Various sampling frequency offsets between the different sampling frequencies may be used, e.g., about 50 Hz in the illustrated implementation. It will be appreciated that such accelerometer data may be extracted in an external device by computing deltas from sample to sample and converting the accelerometer data back to X, Y, Z spatial values. Then, in block 208, the accelerometer audio signal may optionally also be frequency shifted to a different frequency range.

Next, in block 210, the accelerometer audio signal may optionally be mixed with the secondary microphone audio data, and in block 212, the primary microphone audio signal and the mixed audio signal (or alternatively the accelerometer audio signal, if no secondary microphones are used) are combined into left/right channels of a multi-channel (e.g., stereo) audio signal, and in block 214, the multi-channel audio signal is compressed and encoded, e.g., using an audio codec such as SBC or LC-3. The compressed and encoded audio signal is then communicated to an external device (e.g., a mobile phone) in block 216. Recovery of the accelerometer data and primary and/or secondary audio data in the external device, and usage of the data in connection with enhancing a speech input, may then be performed in a similar manner to that described above in connection with FIG. 3.

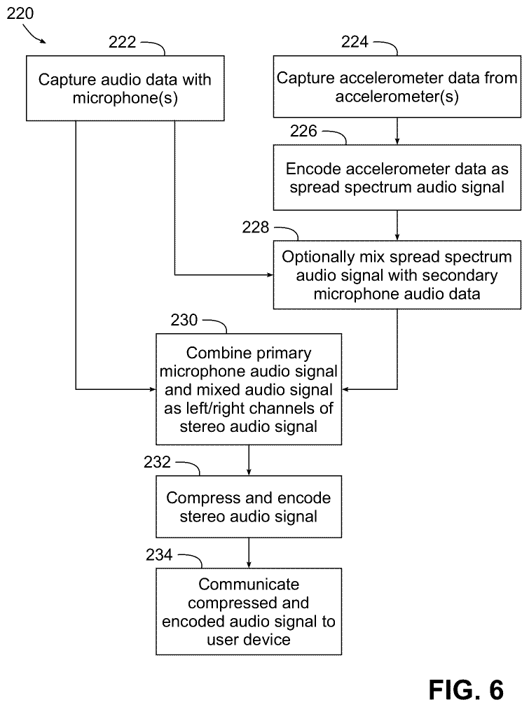

FIG. 6 next illustrates another example operational sequence 220 for communicating a speech input from a wearable device to an external device, in accordance with various implementations, and utilizing a spread-spectrum audio signal to communicate accelerometer data. In block 222, audio data is captured with one or more microphones of the wearable device, e.g., one or more primary microphones, and in some implementations, one or more secondary microphones. Concurrently, accelerometer data is captured from one or more accelerometers of the wearable device in block 224.

Next, in block 226, the accelerometer data is encoded as a spread spectrum audio signal. For example, a Code Division Multiple Access (CDMA) encoding scheme may be used in some implementations to encode the accelerometer data. In some implementations, the accelerometer data may be combined into a single data stream, while in other implementations, separate axis-specific data streams may be used, and in some instances, assigned different codes under a CDMA encoding scheme. In some implementations, the frequency spectrum may correspond to at least a portion of the audio spectrum, such that the spread-spectrum audio signal may be processed using audio codecs and libraries and decoded in an external device with minor, if any, modifications to any audio processing hardware and/or software. In addition, in some implementations, different CDMA codes may be assigned to different frames, although other encoding schemes may be used in other implementations.

Next, in block 228, the spread spectrum accelerometer audio signal may optionally be mixed with the secondary microphone audio data, and in block 230, the primary microphone audio signal and the mixed audio signal (or alternatively the spread spectrum accelerometer audio signal, if no secondary microphones are used) are combined into left/right channels of a multi-channel (e.g., stereo) audio signal, and in block 232, the multi-channel audio signal is compressed and encoded, e.g., using an audio codec such as SBC or LC-3. The compressed and encoded audio signal is then communicated to an external device (e.g., a mobile phone) in block 234. Recovery of the accelerometer data and primary and/or secondary audio data in the external device, and usage of the data in connection with enhancing a speech input, may then be performed in a similar manner to that described above in connection with FIG. 3, with CDMA decoding (or decoding compatible with the encoding scheme used) used to extract the accelerometer data from the spread spectrum audio signal.

### Computing Device

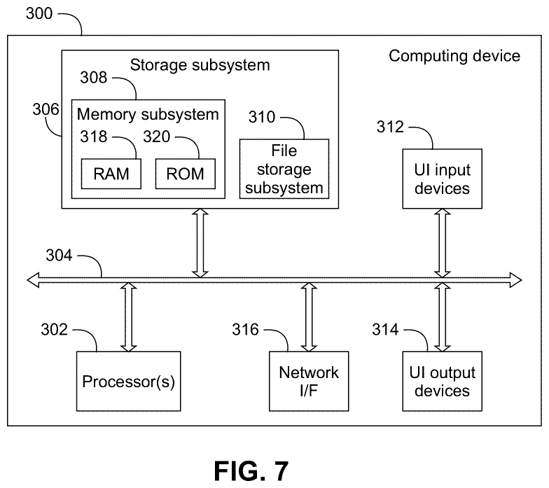

FIG. 7 is a block diagram of an example computing device 300 suitable for implementing all or a part of the functionality described herein. Computing device 300 typically includes at least one processor 302 that communicates with a number of peripheral devices via bus subsystem 304. These peripheral devices may include a storage subsystem 306, including, for example, a memory subsystem 308 and a file storage subsystem 310, user interface input devices 312, user interface output devices 314, and a network interface subsystem 316. The input and output devices allow user interaction with computing device 300. Network interface subsystem 316 provides an interface to outside networks and is coupled to corresponding interface devices in other computing devices.

User interface input devices 312 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 300 or onto a communication network.

User interface output devices 314 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 300 to the user or to another machine or computing device.

Storage subsystem 306 stores programming and data constructs that provide the functionality of some or all of the modules described herein. For example, the storage subsystem 306 may include the logic to perform selected aspects of the various operational sequences illustrated in FIGS. 2-6.

These software modules are generally executed by processor 302 alone or in combination with other processors. Memory 308 used in the storage subsystem 306 can include a number of memories including a main random access memory (RAM) 318 for storage of instructions and data during program execution and a read only memory (ROM) 320 in which fixed instructions are stored. A file storage subsystem 310 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 310 in the storage subsystem 306, or in other machines accessible by the processor(s) 302.

Bus subsystem 304 provides a mechanism for enabling the various components and subsystems of computing device 300 to communicate with each other as intended. Although bus subsystem 304 is shown schematically as a single bus, alternative implementations of the bus subsystem may use multiple busses.

Computing device 300 can be of varying types including a mobile device, a smartphone, a tablet, a laptop computer, a desktop computer, a wearable computer, a programmable electronic device, a set top box, a dedicated assistant device, a workstation, a server, a computing cluster, a blade server, a server farm, or any other data processing system or computing device. Due to the ever-changing nature of computers and networks, the description of computing device 300 depicted in FIG. 7 is intended only as a specific example for purposes of illustrating some implementations. Many other configurations of computing device 300 are possible having more or fewer components than computing device 300 depicted in FIG. 7.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Consistent with some implementations, a method of communicating a speech input received from a user of a wearable device to an external device may include, in the wearable device, capturing audio data with a microphone of the wearable device while receiving the speech input from the user of the wearable device to generate a first audio signal, capturing accelerometer data with an accelerometer of the wearable device while receiving the speech input from the user of the wearable device, converting the captured accelerometer data to a second, narrowband audio signal having a frequency range within about a 2000 Hz frequency range, and wirelessly communicating the first and second audio signals as respective first and second channels of a multi-channel audio signal to the external device.

In some implementations, the wearable device includes an earbud. Also, in some implementations, the microphone is a primary microphone and the wearable device includes at least one secondary microphone, and the method further includes capturing audio data with the second microphone of the wearable device while receiving the speech input from the user of the wearable device to generate a third audio signal, and mixing the third audio signal with the second audio signal such that the second audio signal is communicated in the second channel of the multi-channel audio signal as a mixed signal with the third audio signal.

Further, in some implementations, the second audio signal has a frequency range within about a 1000 Hz frequency range. In some implementations, the second audio signal has a frequency range within about a 500 Hz frequency range. In addition, some implementations may also include frequency shifting the second audio signal to a higher frequency range in the second channel of the multi-channel audio signal.

In some implementations, converting the captured accelerometer data to the second audio signal includes sampling the accelerometer data with a predetermined sampling frequency. In addition, in some implementations, converting the captured accelerometer data to the second audio signal further includes applying a low pass filter to the sampled accelerometer data. In addition, some implementations may further include compressing and encoding the multi-channel audio signal using an audio codec prior to wirelessly communicating the multi-channel audio signal to the external device.

Some implementations may also include, in the external device receiving the multi-channel audio signal from the wearable device, and decoding and decompressing the multi-channel audio signal. Some implementations may further include, in the external device extracting the accelerometer data and at least the first audio signal from the multi-channel audio signal, enhancing the speech input using the extracted accelerometer data and the first audio signal, performing speech recognition on the enhanced speech input to generate a text input, and initiating processing of the text input by at least one of a local or remote automated assistant or a local or remote generative model. Further, some implementations may also include, in the external device, providing the first and second audio signals from the multi-channel audio signal to at least one of a local or remote automated assistant or a local or remote generative model to initiate processing thereby.

Consistent with some implementations, a method of communicating a speech input received from a user of a wearable device to an external device may include, in the wearable device, capturing audio data with a microphone of the wearable device while receiving the speech input from the user of the wearable device to generate a first audio signal, capturing first axis and second axis accelerometer data with at least one accelerometer of the wearable device while receiving the speech input from the user of the wearable device, sampling the first axis and second axis accelerometer data at first and second sampling frequencies to generate first and second sampled accelerometer data, where the first and second sampling frequencies are different from one another, generating a second audio signal using the first and second sampled accelerometer data, and wirelessly communicating the first and second audio signals as respective first and second channels of a multi-channel audio signal to the external device.

In addition, some implementations may also include capturing third axis accelerometer data with the at least one accelerometer of the wearable device, where the first, second, and third axes are mutually orthogonal, and sampling the third axis accelerometer data at a third sampling frequency that is different from the first and second sampling frequencies to generate third sampled accelerometer data, where the second audio signal is further generated using the third sampled accelerometer data.

In some implementations, the first and second sampling frequencies are offset by about 50 Hz. Moreover, in some implementations, the microphone is a primary microphone and the wearable device includes at least one secondary microphone, and the method further includes capturing audio data with the second microphone of the wearable device while receiving the speech input from the user of the wearable device to generate a third audio signal, and mixing the third audio signal with the second audio signal such that the second audio signal is communicated in the second channel of the multi-channel audio signal as a mixed signal with the third audio signal. In addition, some implementations may further include frequency shifting the second audio signal to a different frequency range in the second channel of the multi-channel audio signal.

Consistent with some implementations, a method of communicating a speech input received from a user of a wearable device to an external device may include, in the wearable device capturing audio data with a microphone of the wearable device while receiving the speech input from the user of the wearable device to generate a first audio signal, capturing accelerometer data with an accelerometer of the wearable device while receiving the speech input from the user of the wearable device, converting the captured accelerometer data to a second, spread-spectrum audio signal, and wirelessly communicating the first and second audio signals as respective first and second channels of a multi-channel audio signal to the external device.

In some implementations, converting the captured accelerometer data to the second, spread-spectrum audio signal includes applying a code division multiple access (CDMA) encoding scheme to the captured accelerometer data.

Other implementations may include a system including one or more processors and memory operably coupled with the one or more processors, where the memory stores instructions that, in response to execution of the instructions by one or more processors, cause the one or more processors to perform any of the aforementioned operations. Other implementations may include at least one non-transitory computer-readable medium including instructions that, in response to execution of the instructions by one or more processors, cause the one or more processors to perform any of the aforementioned operations.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method of communicating a speech input received from a user of a wearable device to an external device, comprising, in the wearable device:
capturing audio data with a microphone of the wearable device while receiving the speech input from the user of the wearable device to generate a first audio signal;
capturing accelerometer data with an accelerometer of the wearable device while receiving the speech input from the user of the wearable device;
converting the captured accelerometer data to a second, narrowband audio signal having a frequency range within about a 2000 Hz frequency range; and
wirelessly communicating the first and second audio signals as respective first and second channels of a multi-channel audio signal to the external device.

2. The method of claim 1, wherein the wearable device comprises an earbud.

3. The method of claim 1, wherein the microphone is a primary microphone and the wearable device includes at least one secondary microphone, and the method further comprises:
capturing audio data with the second microphone of the wearable device while receiving the speech input from the user of the wearable device to generate a third audio signal; and
mixing the third audio signal with the second audio signal such that the second audio signal is communicated in the second channel of the multi-channel audio signal as a mixed signal with the third audio signal.

4. The method of claim 1, wherein the second audio signal has a frequency range within about a 1000 Hz frequency range.

5. The method of claim 4, wherein the second audio signal has a frequency range within about a 500 Hz frequency range.

6. The method of claim 1, further comprising frequency shifting the second audio signal to a higher frequency range in the second channel of the multi-channel audio signal.

7. The method of claim 1, wherein converting the captured accelerometer data to the second audio signal includes sampling the accelerometer data with a predetermined sampling frequency.

8. The method of claim 7, wherein converting the captured accelerometer data to the second audio signal further includes applying a low pass filter to the sampled accelerometer data.

9. The method of claim 1, further comprising compressing and encoding the multi-channel audio signal using an audio codec prior to wirelessly communicating the multi-channel audio signal to the external device.

10. The method of claim 1, further comprising, in the external device:
receiving the multi-channel audio signal from the wearable device; and
decoding and decompressing the multi-channel audio signal.

11. The method of claim 10, further comprising, in the external device:
extracting the accelerometer data and at least the first audio signal from the multi-channel audio signal;
enhancing the speech input using the extracted accelerometer data and the first audio signal;
performing speech recognition on the enhanced speech input to generate a text input; and
initiating processing of the text input by at least one of a local or remote automated assistant or a local or remote generative model.

12. The method of claim 10, further comprising, in the external device, providing the first and second audio signals from the multi-channel audio signal to at least one of a local or remote automated assistant or a local or remote generative model to initiate processing thereby.

13. A computer-implemented method of communicating a speech input received from a user of a wearable device to an external device, comprising, in the wearable device:
capturing audio data with a microphone of the wearable device while receiving the speech input from the user of the wearable device to generate a first audio signal;
capturing first axis and second axis accelerometer data with at least one accelerometer of the wearable device while receiving the speech input from the user of the wearable device;
sampling the first axis and second axis accelerometer data at first and second sampling frequencies to generate first and second sampled accelerometer data, wherein the first and second sampling frequencies are different from one another;
generating a second audio signal using the first and second sampled accelerometer data; and
wirelessly communicating the first and second audio signals as respective first and second channels of a multi-channel audio signal to the external device.

14. The method of claim 13, further comprising:
capturing third axis accelerometer data with the at least one accelerometer of the wearable device, wherein the first, second, and third axes are mutually orthogonal; and
sampling the third axis accelerometer data at a third sampling frequency that is different from the first and second sampling frequencies to generate third sampled accelerometer data, wherein the second audio signal is further generated using the third sampled accelerometer data.

15. The method of claim 13, wherein the first and second sampling frequencies are offset by about 50 Hz.

16. The method of claim 13, wherein the microphone is a primary microphone and the wearable device includes at least one secondary microphone, and the method further comprises:
capturing audio data with the second microphone of the wearable device while receiving the speech input from the user of the wearable device to generate a third audio signal; and
mixing the third audio signal with the second audio signal such that the second audio signal is communicated in the second channel of the multi-channel audio signal as a mixed signal with the third audio signal.

17. The method of claim 13, further comprising frequency shifting the second audio signal to a different frequency range in the second channel of the multi-channel audio signal.

18. A computer-implemented method of communicating a speech input received from a user of a wearable device to an external device, comprising, in the wearable device:
capturing audio data with a microphone of the wearable device while receiving the speech input from the user of the wearable device to generate a first audio signal;
capturing accelerometer data with an accelerometer of the wearable device while receiving the speech input from the user of the wearable device;
converting the captured accelerometer data to a second, spread-spectrum audio signal; and
wirelessly communicating the first and second audio signals as respective first and second channels of a multi-channel audio signal to the external device.

19. The method of claim 18, wherein converting the captured accelerometer data to the second, spread-spectrum audio signal includes applying a code division multiple access (CDMA) encoding scheme to the captured accelerometer data.
